(19) United States
(12) Patent Application Publication
(10) Pub. No.: US 2003/0038976 A1
(43) Pub. Date: Feb. 27, 2003

(54) Half-tone screen printing process

(75) Inventor: Michael A. Masotti, Comack, NY (US)

Correspondence Address: DARBY & DARBY P.C., P. O. BOX 5257, NEW YORK, NY, 10150-5257, US

(73) Assignee: Allen Simon

(21) Appl. No.: 09/940,553

(22) Filed: Aug. 27, 2001

(51) Int. Cl. H04N 1/405; G06K 15/02; H04N 1/52; B41C 1/12; B41C 1/00

(52) U.S. Cl. 358/3.12; 358/534; 358/3.3

(57) ABSTRACT

An AM half-tone screening process having special utility with a flexographic printing process is described. Such printing processes typically include a desktop publishing unit, a raster image processor for forming half-tone separations, and an image sitter for producing the half-tone separations. In accordance with the invention, the image area is divided into a multiplicity of groups of equally spaced dots. The combined value of the dots in a single group is set at a desired target film value but the individual dots vary in size for film values below a selected transition level. The minimum value of one of the dots can be determined by the operator of the system and, for example, may be greater than the size of the anilox cells in the printing process so that emersion of the raised area into the cell is not possible. The remaining dots of the group decrease in size in proportion to the target film value at a faster rate than the first dot.

### FIELD OF THE INVENTION

This invention relates to half-tone screen printing and, more particularly, to a half-tone screen printing process of the type particularly well adapted for use in flexographic printing.

### BACKGROUND OF THE INVENTION

In many different printing processes half-tone dots are used to represent different tones for a particular ink color. The human eye perceives the combination of dots on the substrate as a tone which may be a single color or a multi-color half-tone. There are two approaches in producing half-tones. One approach is known as amplitude modulation (AM) which consists of half-tone dots that vary in size according to the desired half-tone value. The dot size varies in the AM half-tone approach, but the dot-to-dot distance does not vary for a given half-tone frequency. The greater the frequency or resolution, which is measured in “lines per inch” (lpi), the smaller the dots and the shorter the distance between the dots. The AM screening approach is easily controlled and proofed, but when used with high resolution screens it is difficult to control accurately the size of the dots for very low film values, e.g. for film values less than 5% which typically correspond to highlight areas.

In frequency modulation (FM) screening, the same size dots are used, but the spacing between adjacent dots is varied according to the lightness or darkness of the pixels. FM screening is capable of providing high quality highlighting. However, the FM screening approach is difficult to control and proof and has a grainy appearance.

Hybrid screening, which is a combination of AM and FM screening, is also difficult to proof and there is an undesirable visible transition where the AM screen overlaps the FM screen. Moreover, hybrid screening is relatively expensive and requires precise calibration of the film output.

Flexographic printing has gained increasing popularity because of its ability to print on many different substrates, the large number of colors which can be provided, and its relatively low cost. In a conventional flexographic printing arrangement as shown in FIG. 1, a photopolymer plate 10 is prepared from a photographic film which may include solid and half-tone images. The photopolymer plate is prepared by placing a negative over the plate and exposing the photopolymer plate through the negative. The exposed photopolymer plate is then processed in a wash out unit which washes away the unexposed areas leaving the exposed areas as a raised image surface 12.

The photopolymer plate is pliable so that it can be wrapped around a plate cylinder 14 which rotates in a counterclockwise direction. An anilox roller 16, which includes a multiplicity of microscopic cells 18, rotates with the plate cylinder 14 and transfers ink from the cells to the raised image surfaces 12 which, in the case of a half-tone image, are dots of various size and spacing. As the anilox roller 16 rotates, a doctor blade (not shown) meters the ink to a consistent ink film thickness on the surface of the anilox roller. The anilox roller then makes contact with the rotating plate cylinder, depositing a thin film of ink on the raised dots 12 of rotating photopolymer plate 10A. The photopolymer plate then engages the substrate 20 disposed on a rotating impression roller 22 and transfers a percentage of the ink on the photopolymer plate to the substrate as the substrate is passed through a web.

In a half-tone process, when the raised “dots” on the photopolymer plate are small (e.g. for dot values less than 5%), the raised dots 12 are subject to immersion in the spaced cells 18 on the anilox roller if the size of the dot is smaller than the diameter of the anilox cell. Because of the small size of these dots, during the printing process they are 10 subject to “overinking”, compression and bending. As a result, the size of the dot actually printed is larger than the intended size, a phenomenon known as “dot gain”. Furthermore, as the printed image fades to the substrate color, the excessive dot gain at low screen values tends to cause an obvious transition which is referred to as “dirty edge”. In a conventional AM half-tone screen, the standard minimum dot value is 2-5% on a photopolymer plate. 1 5 After this plate is printed, the gain can be anywhere from 8-20% on a 150 line screen under the best printing conditions.

To deal with excessive dot gain in the highlight areas, it is customary to overexpose the image in an effort to compensate for the gain. The problem with this approach is that the entire image is overexposed which results in increased dot gain throughout the entire image.

Furthermore, in a flexographic screen printing process, when dot sizes are small, they may not be exposed, or they may be washed out during the washing procedure, in which case the gray value which they are intended to represent will not appear on the printed image.

It is an object of this invention to provide an improved screen printing process in which very low dot values can be accurately reproduced.

A more specific object of the invention is to provide an improved half-tone printing process for use in flexographic printing which avoids the undesirable phenomenon of “dirty edge” in areas where dot values are low.

A further object of the invention is to provide a computer controlled half-tone printing process wherein the software can be easily modified to provide improved half-tones for very low dot values.

A still further object of the invention is to provide a half-tone printing process which, at low dot values, gradually transitions from a fine screen to a coarser screen without any undesirable visual affect.

It is a still further object of the invention to provide a half-tone printing process in which it is not necessary to overexpose an image to compensate for excessive dot gain in highlight areas.

It is yet a further object of the invention to provide a half tone printing process which does not have the disadvantages of hybrid screening techniques.

### BRIEF DESCRIPTION OF THE DRAWINGS

FIG. 1 is an illustration of a conventional flexographic printing device showing how printing takes place;

FIG. 2 is a block diagram showing the various steps in a flexographic printing process;

FIGS. 3A and 3B are explanatory diagrams showing half-tone images at a 50% dot value for a high resolution (200 lpi) and a coarse resolution (100 lpi) screen;

FIGS. 4A and 4B show typical dot patterns for a 1% target film value for a 200 line screen and a 100 line screen in a prior art AM flexographic screen;

FIG. 5 is a map showing how an image area is divided into individual cells in accordance with the invention;

FIG. 6 is an illustration of dot size in accordance with the invention for a target film values ranging from 11% down to 0; and

FIG. 7 illustrates a graphical user interface which enables the user to control a half tone screen printing process in accordance with the invention.

### SUMMARY OF THE INVENTION

In a half-tone screening process, the image area is divided into a multiplicity of groups or cells, for example, of four dots each. The combined value of the four dots in a single group equals the desired target film value, but the individual dots vary in size for film values below a selected transition level. The minimum value of one of the four dots preferably is determined by the operator of the printing system. For example, the minimum size can be larger than the size of a selected anilox cell in a flexographic printing process so that immersion of the raised area corresponding to the dot is prevented. The three remaining dots decrease in size in proportion to the target film value at a faster rate than the first dot. The effect is to provide a gradual transition from a fine resolution to a coarse resolution as dot values decrease below the transition value.

### DETAILED DESCRIPTION OF THE INVENTION

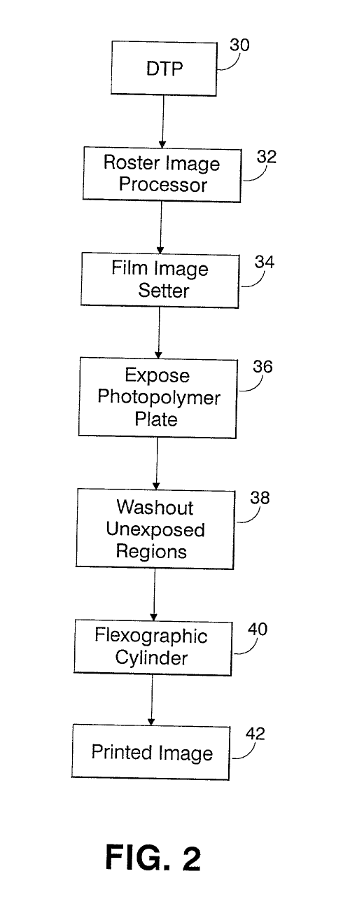

FIG. 2 schematically illustrates a half-tone flexographic printing process. The invention is not necessarily limited to flexographic printing and would have utility in any AM half-tone printing process, i.e. a half-tone process in which dot values are dependent on dot size and spacing is constant. The term “dot value” refers to the percentage of the image area which is opaque. A dot value of 100% would be entirely opaque and a dot value of 0% would be fully transparent. Typically, dot values between 2 and 5% are designated for highlight areas and represent the range in which disintegration of the dots and thus excessive dot gain appears.

In FIG. 2, a desktop publishing unit 30 which may be a conventional Macintosh computer or PC produces a digital image which is coupled to a raster image processor (RIP) 32 in which the half-tone image is created. The raster image processor 32 (for example, and adobe PostScript processor) receives information from the desk top publishing unit 30 via software that converts graphic information into PostScript language code (for example) which is a programming language widely used in the printing industry. The processor 32 then creates a bit mapped image (a raster) which can be imaged onto film or paper by an image setter 34, which may also be conventional, and produces a half-tone image by means of a laser.

The raster image processor determines the size and shape of the dots, their frequency (lines per inch), and the proper angle of rotation. These variables are determined by information stored in the processor 32 in the form of a “screen set” which contains the optimum angles of rotation and exact frequencies for a given frequency so as to avoid a moire pattern. Each RIP manufacturer has its own proprietary algorithms which comprise a “screen set” and determine the aforementioned printing parameters. The half-tone image is then plotted on an address grid according to this information. The laser within the image setter 34 either turns on or off at the individual locations on the address grid according to the stored half-tone information in the raster image processor.

The half-tone film produced by image setter 34 is then placed on top of a photopolymer plate at 36 and the plate exposed to light through the negative image. The exposed photopolymer plate is then passed to a wash-out station 38 in which the unexposed regions of the plate are removed by washing. In an AM half-tone screening process, when the dot values are below 2% on a half-tone with a fine line screen (e.g., above 150 lpi), the dots are subject to removal during the washing process. Likewise, as mentioned above, if the dots on the photopolymer plate are smaller than the anilox cells, they are subject to immersion in the cell in which case they tend to absorb too much ink, leading to excessive dot gain and “dirty edge”.

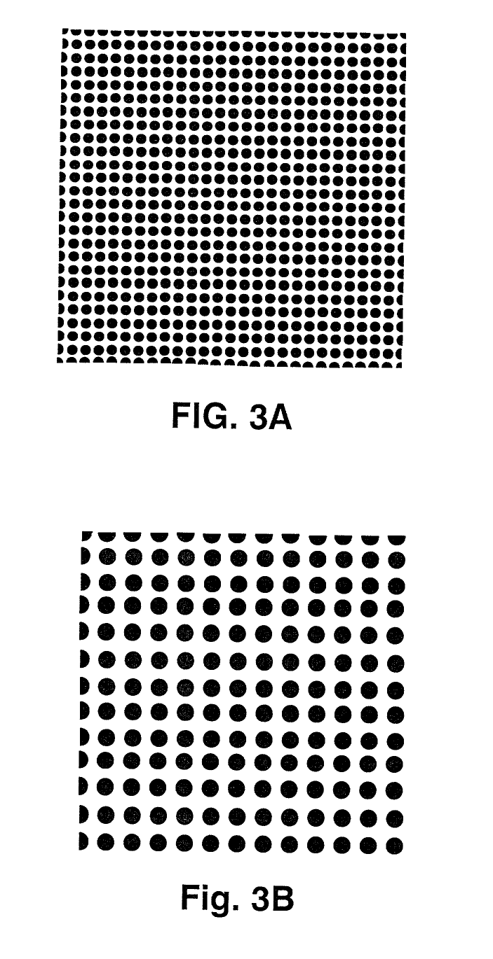

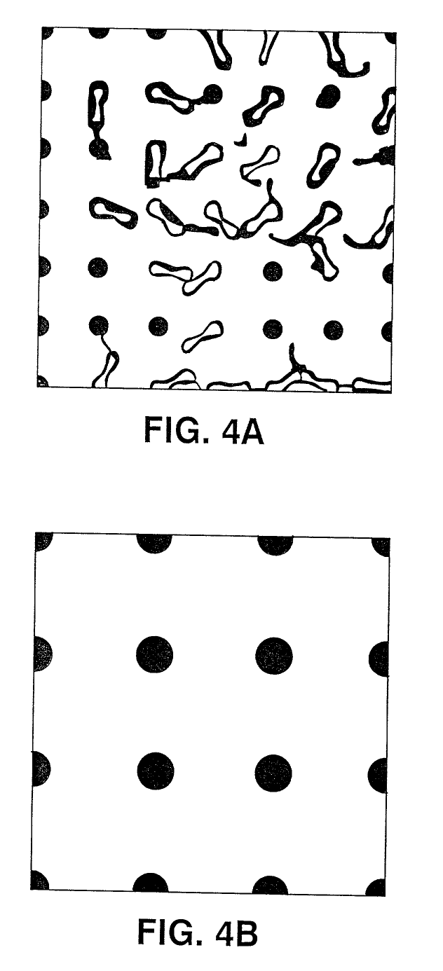

In an AM half-tone process, resolution is measured in lines per inch (lpi). FIG. 3A is a magnified view of a 200 lpi screen at 50% dot value and FIG. 3B illustrates a 100 lpi half-tone screen at the same dot value. Each dot in the 100 lpi screen of FIG. 3B is four times the size of a dot in the 200 lpi screen of FIG. 3A and the spacing between adjacent dots is twice as large in FIG. 3B. As shown in FIGS. 4A and 4B, which represent a 1% dot value, in the case of the 200 lpi half-tone, many of the dots are distorted which gives rise to the “dirty edge” effect. The larger, i.e. coarser screen of FIG. 4B has the same dot value (1%) but none of the dots have disintegrated. Hence, the image is coarser, but clean.

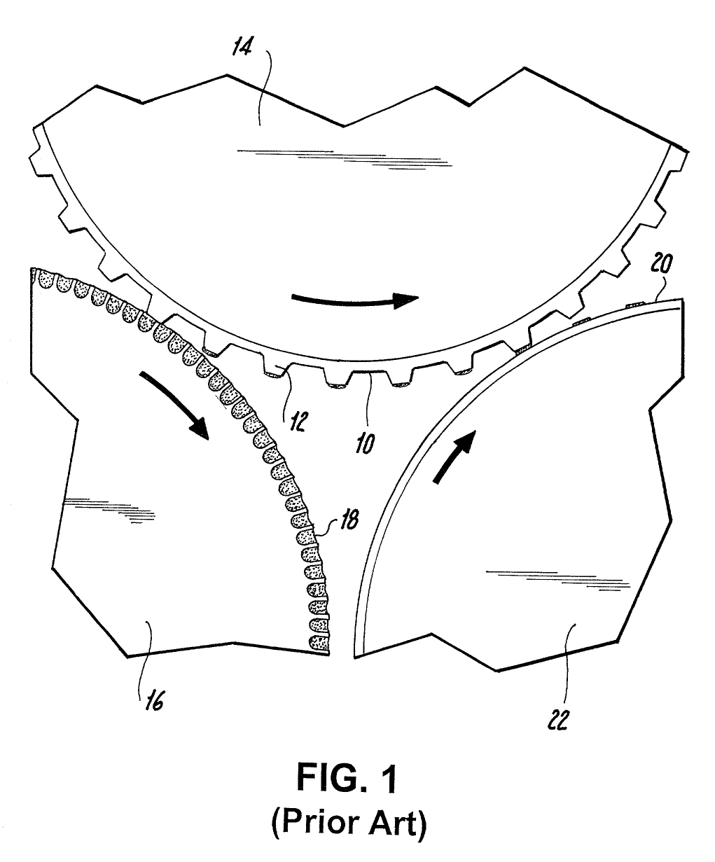

For a large dot values (e.g. greater than 10%) the likelihood of dot disintegration is low; therefore, ideally a higher (e.g. 200 lpi) screen would be used for dot values greater than 10% but for lower dot values, the coarser (e.g. 100 lpi) screen would be used. This avoids the “dirty edge” problem but leads to a relatively sharp transition between the coarse and fine screens. It is also difficult to implement with current printing systems as represented in FIG. 1.

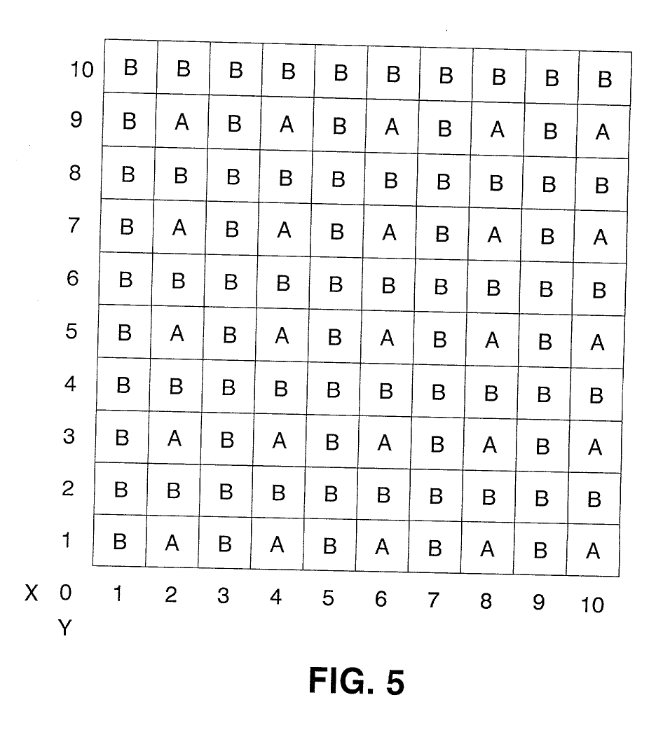

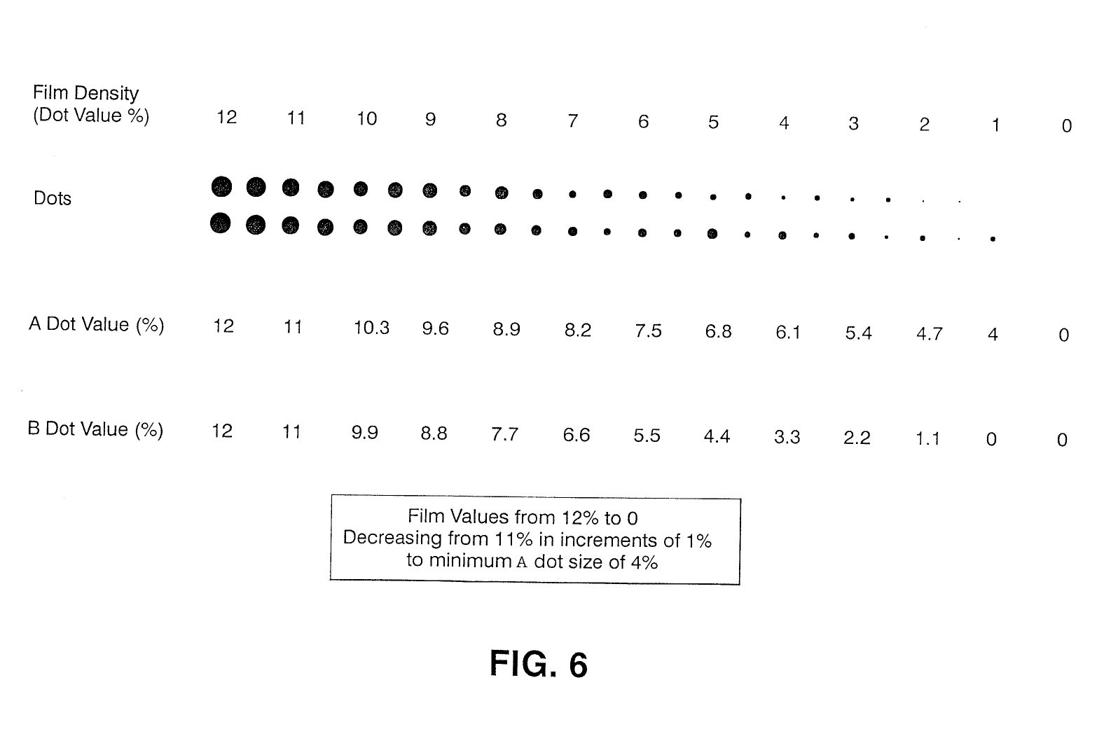

In accordance with the invention, for image gray values below a predetermined threshold, certain ones of the dots diminish in size at a rate faster than the other dots as density decreases, i.e. as the image becomes more transparent. This is explained in greater detail below with respect to FIGS. 5 and 6.

FIG. 5 is a “map” which represents an area to be reproduced as a half-tone image. The map comprises a ten-by-ten matrix resulting in 100 locations where a dot may appear in an AM system. The density or gray value of the image depends on the size of the individual dots which, in an AM system, are equally spaced for a given screen.

In accordance with the preferred embodiment of the invention, the half tone image is divided into a multiplicity of groups or cells of four dots each; thus the area shown in FIG. 5 is divided into twenty-five individual cells. Each cell includes an A dot and three B dots. If the map is assigned X and Y coordinates, then each A dot corresponds to the combination of an odd Y coordinate and an even X coordinate.

Ordinarily, as indicated above, all of the A and B dots are the same size for a given density. As the target film values decrease, reflecting a lighter image, it is necessary that the dot size decrease also thereby representing a lighter image. In a conventional AM screen, all of the dots would diminish in size by the same amount. In accordance with the invention, however, when the density is below a predetermined transition level (for example, 11%) the dot sizes are no longer equal; the B dots diminish in size at a faster rate than the A dots as density decreases.

The principals of the invention are explained below with reference to FIG. 6. FIG. 6 is a chart which reflects the size of the A and B dots for a target film density which diminishes from a gray value of 12% to 0. In FIG. 6, the target film value is shown diminishing in increments of 1% to a minimum dot size for the A dots of 4%.

In the preferred embodiment, the raster image processor 12 calculates dot size based on information entered by the operator regarding the minimum dot size for the A dots and the transition value. These variables are described separately below.

It is recalled that the invention has particular utility in a flexographic printing process where the protruding dots on a photopolymer plate contact anilox cells 18 (FIG. 1) to receive ink. In the preferred embodiment, the minimum dot size for the A dots should be greater than the diameter of the anilox cells since this will prevent immersion of the raised dots into the cells. If the A dots are larger than the cells, the B dots can be smaller since they will be supported by the adjacent larger A dots and therefore will not be immersed which, as explained above, can lead to excessive gain. Since the operator knows the size of the anilox cells, it is a simple matter to select a size for the A dots which is greater than the anilox cell size. As an example, if a dot frequency of 200 lpi is desired, 1200 anilox cells per inch is required. The cell diameter in that case is about 19 microns so that a 25 micron dot could be the minimum A dot size. This would be roughly equivalent to a dot value of 3% at 200 lpi or to a dot value of 0.75% at 100 lpi. For purposes of the example of FIG. 6, it is assumed that the minimum A dot value is 4%.

The transition value is the target film value where the gradual transition from a fine screen to a coarser screen starts to take place. This is under the operator's control and will be selected depending on the specific situation at hand. In some cases, a transition value of 20% (or higher) may be desirable; in others, the transition value may be less than 11%. The objective is to provide a smooth transition for the B dots from their transition value to disappearance. This will depend on resolution and the image area in which the transition is to take place. In this example, a transition value of 11% has been selected, i.e. for a target film density of 11% or less, there is a gradual transition from a fine to a coarse screen. Stated in other words, for target film values greater than 11%, all of the dots are equal in size as is customary in an AM screen. For values of 11% and less, the A dot will be larger than the three B dots in a prescribed ratio which is calculated by the selected software and imaged by the raster image processor.

Once these variables have been determined and entered into the raster image processor 32 by the desk top publishing unit 30, the processor calculates the B dot sizes for each of the target film values. This is a relatively simple calculation and is done in the following way.

First, since the A dot values decrease from 11 to 4 in 10 equal increments as the target film value goes from 11% to 1%, the A dot value is reduced by 0.7% for each target film value increment of 1%. This is shown in the third row in FIG. 6.

Second, knowing the A dot value, the B dot value is calculated by selecting a value for each of the three B dots which, when combined with the A dot value, will result in an average value equal to the desired target film value. In other words, if an average target film value of 10% is desired for the four dots in a cell, the total of the four dot values must equal 40. If the A value is 10.3, then the three B dots must equal 29.7. Hence, each of the individual B dots must equal 9.9 (29.7÷3). The B dot values for each target film value from 10% to 1% are calculated in the same way. At the film target value of 1%, the A dot value is 4% which means that the B dot values must be 0.

At very low film values (4% and less in the example of FIG. 6), the size of the B dots is less than the size of the anilox cells. Normally, this would mean that they would be subject to immersion in the anilox cells during the flexographic printing process, but the larger A dots on the photopolymer plate prevent such immersion. At very low values, the B dots may be washed away during the washing step but this will not significantly alter the overall affect of the half tone screen because of the A dots.

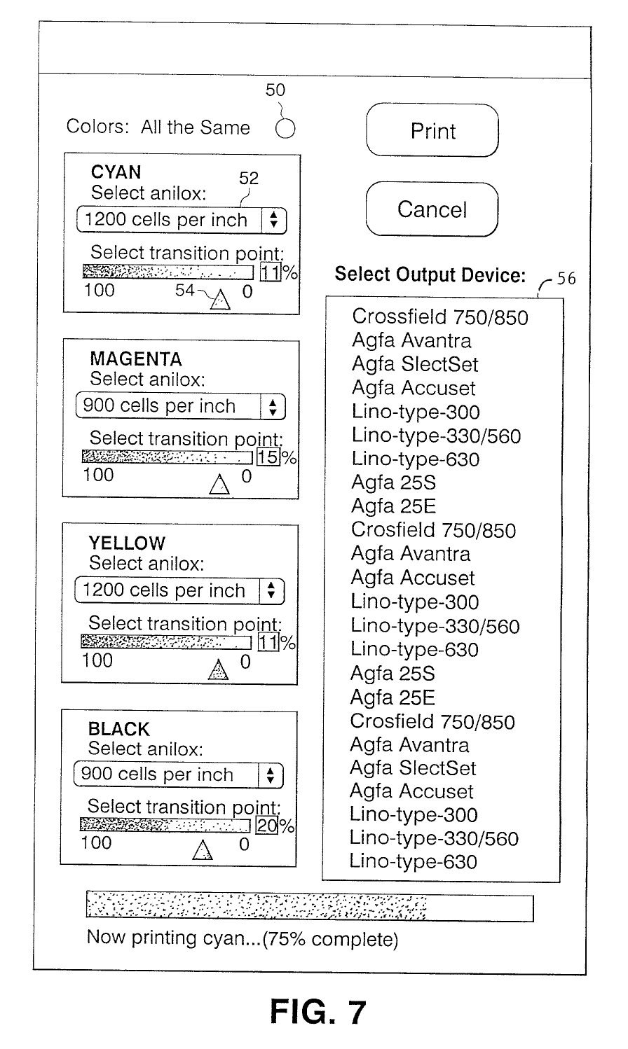

The desktop publishing unit 30 is a computer which, as mentioned above, provides digital information representing the image to be processed to the raster image processor. By way of example, a Macintosh desktop publishing unit manufactured by Apple Computer may be used. FIG. 7 shows one graphical user interface which may be displayed on the computer monitor in a typical color printing process in which cyan, magenta, yellow and black separations are formed. The invention, of course, is not limited to particular separations.

By clicking on the circle 50, the user can cause the four color separations to be modified globally. When selected, the number of anilox cells per inch and the transition point will be the same for each separation. If it is not selected, then each of the separations is controlled independently.

Since each of the color separations is controlled in the same way, only cyan is described below. The information in the window 52 determines the minimum dot size for the half-tone. As an example, the default setting in the window 52 may be predetermined depending upon the frequency (lpi) selected from within the desktop application at the time of printing using, for example, a 6 to 1 ratio of anilox line screen to half-tone frequency. Thus, if the user wants to print with a half-tone frequency of 150 lpi, the anilox selectors will open with a default of 900 cells per inch. This will ensure that the minimum dot size of the half-tone is larger than the cell opening of the anilox.

If the operator does not have the desired anilox in inventory but must use the desired 150 lpi frequency, the minimum dot size of the A dots will be increased to accommodate the anilox cell opening. The B cells will be modified accordingly.

A transition point between 100% and 0 can be selected by moving the slider 54. As explained above, the selection of the transition point determines the image grey value at which the A and B dots start to diminish at different rates. The combination of the anilox selection and transition point selection determines the values of the A and B dots for every image value less than the selected transition value.

By highlighting one of the indicated output devices in the window 56 entitled “select output device”, the user can access the appropriate raster image processor for the output device which is being used. Each RIP manufacturer has its own software (screen set) for producing optimal moire free print results. The actual angle and frequency often vary from the selected frequency depending on color and frequency. When an output device has been highlighted, the software will collect the half-tone frequency and angle for a given frequency for that output device. Based on this information, the software will set up a grid with an XY coordinate system. It will then rotate the grid according to the desired angle and calculate the A and B dot values on that grid. Pixel information for grey values in the image that are below the starting transition point are then replaced by the new values calculated by the software. Values that are above the transition point remain intact. Since all of these calculations are made in the desktop publishing unit (i.e. the computer), it is unnecessary to modify or reprogram the raster image processor.

The invention thus provides a modified AM screen in which a high resolution screen is used throughout most of the image area with a gradual transition to a coarser screen in the low density or highlight areas. The transition is less noticeable than a combination of FM and AM screening because AM screening is used for the entire image. The photopolymer plate is able to hold a 1% dot because it is larger (for the coarser screen). Because it results in less dot gain, there is no need to overexpose the highlight areas which would result in higher dot gain throughout the entire image.

In effect, the invention provides a transition from a fine screen (e.g. 200 lpi) to a coarse screen (e.g. 100 lpi) for very low film values, but in a gradual way so that the difference between the two screens is not visible to the eye.

The calculation of dot size may occur in the raster image processor (such as an Adobe PostScript processor) which provides digital output signals for the film imagesetter, or which images the half-tone directly onto a printing plate. The calculation can also take place at the desktop publishing platform (such as Macintosh or Windows operating systems), or as a “plug-in” to existing applications such as Adobe Photo Shop and Adobe Illustrator which would incorporate the above principles to modify existing screen sets in the raster image processor by adjusting tonal values on a dot by dot basis.

I claim:

1. An AM half-tone printing process wherein shades of gray are represented by dot size, comprising
representing at least some shades of gray by groups of equally spaced dots in each of which some dots are smaller than at least one other dot in the group.

2. An AM half-tone printing process according to claim 1, wherein the average size of the dots in a single group corresponds to a predetermined dot value for the group as a whole.

3. An AM half-tone printing process according to claim 2, wherein there is a predetermined minimum size for said at least one other dot.

4. An AM half-tone printing process according to claim 2, wherein each group includes n dots, and gray values below a predetermined transition value are represented by reducing the sizes of n−1 of said dots to values which are less than the value of the remaining dot.

5. An AM half-tone printing process according to claim 3, wherein each group includes n−1 dots, and gray values below a predetermined transition value are represented by 3reducing the sizes of n−1 of said dots to values which are less than the value of the remaining dot.

6. An AM half-tone printing process according to claim 5, wherein n=4.

7. An AM half-tone printing process according the claim 4, wherein said minimum size and transition value are variable.

8. An AM half-tone printing process according the claim 7, wherein the printing process is a flexographic printing process.

9. An AM half-tone printing process according to claim 5, wherein a desktop publishing computer couples digital information to a raster image processor to form individual half-tone separations, said minimum size and transition value being determined by said desktop publishing computer.
